(19) United States
(12) Patent Application Publication
(10) Pub. No.: US 2009/0099684 A1
(43) Pub. Date: Apr. 16, 2009

(54) Tool Wear Correction Method

(75) Inventor: Jurgen Roders, Hamburg (DE)

Correspondence Address: SHERIDAN ROSS PC, 1560 BROADWAY, SUITE 1200, DENVER, CO, 80202, US

(73) Assignee: P&L GmbH & Co. KG, Hamburg (DE)

(21) Appl. No.: 10/567,973

(22) PCT Filed: Jun. 3, 2004
(86) PCT No.: PCT/EP04/06016

§ 371 Date: May 15, 2008

(30) Foreign Application Priority Data
Aug. 14, 2003 (DE) 103 37 489.2

(51) Int. Cl. G05B 19/4065; G06F 19/00

(52) U.S. Cl. 700/173; 700/175; 700/179

(57) ABSTRACT

The present invention relates to a method for machining a workpiece 1 by means of a rotating tool 2 provided with at least one cutting edge 3, in which method the machining operation is interrupted at predetermined time intervals, the tool 2 is moved away from the workpiece 1, and a wear measurement is subsequently carried out on the tool 2, characterized in that after the wear measurement the tool 2 is returned at least into the feed position assumed by it before the interruption and the machining operation is continued, and that subsequently within a period of time the tool is continuously fed for compensating the wear measured.

The present invention relates to a method for machining a workpiece with an automatic tool wear correction.

In detail, the present invention relates to a method according to the features of the preamble of the main claim.

When workpieces are machined by way of milling or grinding, wear is observed on the tool, which is caused by the machining process. This wear leads to a change in the cutting geometry of the tool and subsequently to dimensional deviations on the workpieces to be produced. In many machining processes, such as milling or grinding, the wear arising on the tool is a continuous process which, however, cannot be determined in advance.

To avoid excessive deviations on the workpiece, it is known that the machining process is interrupted and that the tool and/or the workpiece are measured automatically with a suitable measuring device in the machine.

The feed of the tool is then corrected thereafter to machine the workpiece surface in the desired manner true to size.

When a specific wear tolerance limit has been exceeded, the tool can be replaced by a so-called sister tool to continue the machining operation. Such a sister tool resembles the original tool.

With specific machines, e.g. flat grinding machines, a continuous control of the tool or the grinding disk is also known during the machining operation. Such a continuous control is used for continuously correcting the wear during machining in the controller through a continuous feed in the machine. In many machines, such a method is however not possible because technically the geometry of the tool cannot be measured during the machining process. The process must be interrupted in such machines to measure the tool.

This method, however, has the drawback that the wear is only measured at intervals with a delay. With machines having short machining times for a surface, e.g. lathes, this plays no major role because the tool can always be measured after a coherent area has been machined.

In machines requiring long machining times for an area, e.g. milling cutters for tool and die construction, an interruption in the machining of an area, a measurement of the tool and a subsequent correction of the tool feed by the wear measured will however lead to a step in the area to be machined, which will later have to be removed by taking great manual finishing efforts, e.g. by polishing.

In many applications, particularly in tool and die construction, the surfaces to be produced are provided with a specific dimensional tolerance range within which these must lie. The surfaces must be of a polishing quality in addition. The attempt is therefore made to produce, already on the machining tool, a surface which is within the tolerance range and achieves a surface quality that is as high as possible, particularly which is free from objectionable steps.

It is the object of the present invention to provide a method of the above-mentioned type which while being of a simple design and executable in a reliable way permits wear correction while avoiding the drawbacks of the prior art. According to the invention the object is achieved by the feature combination of the main claim; the subclaims show further advantageous configurations of the invention.

Hence, according to the invention the tool is returned after wear measurement at least into the feed position assumed by it before the interruption and the machining process is continued, and the tool is continuously fed thereafter within a period of time for compensating the wear measured.

Hence, with the invention it is possible to interrupt the machining process during the machining of a surface as often as desired for the purpose of tool measurement and to correct the measured wear in the controller such that no undesired steps are formed on the surface. As a consequence, much narrower tolerances and better surfaces can be produced during machining.

To this end a kind of creeping correction is employed in the controller. The machining process is interrupted and the wear of the machining tool is then measured in an appropriate device of high accuracy. The measuring device may e.g. be a laser light barrier or a measuring device (measuring diamond) which records the sound created upon contact with the rotating tool, thereby sensing the tool dimension.

After the measuring operation the machining process is first continued according to the invention without the feed of the tool (the tool axes) being corrected by the wear measured. For instance, a step on the surface to be produced is avoided. Instead of this, a “creeping” correction, which can be freely chosen by the operator of the machine, is selected. The necessary correction of the feed of the machine axes is thus carried out continuously during machining.

After the wear measurement has been completed and the tool has been fed again, the tool can also be retracted by a predetermined amount, resulting in a smooth entry of the tool into the workpiece surface. The same method can also be employed upon a tool change.

The speed of the correcting process can be defined through the machining path or a machining time. In addition, the speed can be defined on the basis of the total wear measured or on the basis of a measuring unit, such as 0.001 mm, i.e. e.g. 0.001 mm/min.

It is here also possible that the correction speed is chosen to be so slow that the correction has not been completed yet when the next interruption of the machining process already takes place for the purpose of the next wear measurement. In this case it is possible to produce an error message or a warning message for the operator or also to add up the result of the new wear measurement and the wear correction from the preceding measurement, which correction has not been completed yet, and to let the creeping correction continue with the added-up correction value.

In some applications the workpiece is always machined with one point of the tool edge only. Depending on the inclination of the area to be machined, said point travels along the cutting edge to various places, e.g. in the machining of free-form surfaces in forms with spherical milling tools. Subsequently, the wear will not be uniform on the cutting edge, but will depend on how long the respective point on the cutting edge is in engagement. Therefore, it is necessary in such cases to measure the whole cutting edge, e.g. sectionwise. It is not only one wear value that is sensed for the tool, but the wear is sensed along the cutting edge. In tools having several cutting edges, the rotation of the tool will create an enveloping body. During tool measurement the enveloping body that is created by the highest points of all cutting edges will then be measured.

In this case the wear correction, i.e. the feed of the machine axes, must take into account the point of engagement of the cutting edge(s) that is the respectively current one in machining. The creeping correction of the invention can then only be active for this point of engagement of the cutting edge(s) because, otherwise, with permanently changing points of engagement on the cutting edges, steps would again be created. Hence, a view of the cutting edge that is subdivided into small sections, for instance via a raster of support points, is provided according to the invention. The feed is carried out in a direction normal to the workpiece surface. Hence, the direction of the workpiece surface must be known. This can usually be described via face normal vectors which are output in the machining program.

When the points of engagement of the cutting edge are not known from the machining program, e.g. in the case of milling programs through normal vectors, it is also possible according the invention to compute the machining progress during machining in the controller online, i.e. so to speak to simulate it inside the controller, as is known from simulation programs. Of course, the tool geometry must be known for this purpose, e.g. by measurement. It can be computed online by reason of the permanently calculated material removal which material removal is currently carried out by the cutting edge and where the point of engagement is positioned on the cutting edge. Said point can be used for wear correction.

The online calculation of the material removal can also be used according to the invention for controlling the intervals of the interruption of the machining process for the purpose of tool measurement. When the controller calculates that a very great amount of material is removed, the measurement will be carried out more often.

A slightly coarser method is an averaged method. In this case the wear is also measured along the whole cutting edge, but an average value is then calculated. The “creeping” correction is then carried out on the basis of this average value. It can also be determined that the correction shall only be made in one axis, e.g. the main spindle axis. In this instance, it is even enough when the wear is measured at one point, e.g. the tool tip. This procedure is required if the points of engagement are not known in the controller because of the surface inclination and are not calculated either.

The interval of the wear measurements and the interruptions of the machining process required therefor can be defined via the machining path or the machining time. It is also possible to take the result of the respectively last wear measurement as a measure of the duration of the interval up to the next measurement. For instance, a self-regulating process is created where the measurements are performed more often in case of high wear and less often in case of small wear.

The “creeping” correction can also take place according to the invention in a linear fashion. However, any other desired mathematical functions can be used as well.

During the whole machining operation the whole wear of the machining tool can also be calculated according to the invention. If a total wear tolerance that is predetermined by the operator is exceeded on the tool, the machining process will not be continued with the tool because said tool is too much worn and will no longer perform proper cutting operations. In this case the tool can automatically be replaced by a sister tool.

Moreover, an excessive increase in the wear from one measurement to the next one may have the effect that the tool is classified to be worn too much and the machining operation is either interrupted altogether or continued with an appropriate sister tool.

In some machining operations the tool slightly drifts off during machining, i.e. the tool is pressed away from the workpiece surface by the cutting forces, resulting in an undesired allowance, for instance in long milling tools performing a lateral machining operation. The drift can vary depending on the wear, i.e. in a new sharp tool the drift is smaller than in a slightly worn tool. Of course, this drift also leads to dimensional deviations on the workpiece. According to the invention this wear-dependent drift can additionally be taken into account in the “creeping” wear correction through empirical values stored in the controller accordingly. In this case the wear will be slightly overcompensated for compensating for the drift which is increasing with an increasing wear.

The use of sister tools is known in machines. A sister tool is automatically used as a substitute when a certain wear limit has been exceeded. Wear is here e.g. measured at intervals as described above. When a wear tolerance which is predetermined by the operator or is stored in the controller is exceeded on the tool, the machine automatically takes a sister tool of identical geometry as a substitute and continues the machining operation with said sister tool. To observe narrow tolerances, it is known that the controller returns in the machining program to the place where the last wear measurement was taken and continues the machining operation from said place. For instance, the area of the workpiece where the wear tolerance was exceeded during machining is once again machined with the new tool to compensate for the wear tolerance that has been exceeded. In this method, however, steps may also be formed on the surface of the workpiece. This is due to the fact that the new sister tool is sharper than the preceding tool. When the machining operation starts at the place of the last measurement, the cutting forces in the new and sharp tool are smaller and it is thus pressed away from the workpiece surface to a lesser degree and, as a consequence, removes more material. That is why a step is formed in the workpiece surface at said place.

Such undesired steps on the workpiece surface during the use of sister tools can also be avoided by a “creeping” feed according to the invention. The new sister tool will start the machining operation as described above at the program place of the previous tool measurement. However, the machining operation starts with a minor tool correction, so that the new sister tool does not remove material at the beginning because the area was already machined by the preceding tool. Hence, it remains slightly above the workpiece surface. During the program run there is again a slow feed movement, i.e. the tool correction is slowly reduced, so that the tool slowly approaches the material surface produced by the preceding tool and finally immerses very slowly into the material, starting to remove some material. An almost tangential transition is thereby created and the undesired steps are avoided. It is not necessary in this method to continue the machining operation with the sister tool exactly at the place of the last measurement. To have an adequate machining path at one's disposal for the slow feed, it is possible to return to places even further back in the machining program.

In many applications machining tools of different sizes are used. This is e.g. required for milling tasks when small inner radii must be machined that are positioned next to relatively large surfaces. In these cases the large surface is normally machined with a tool having a large diameter, so that the machining times are not so long and the line spacing between the tool paths need not be so narrow for obtaining a good surface. For the machining of the small inner radii a tool is then used having a small radius. Undesired steps on the workpiece surface are most of the time also created by the tool change. These steps are due to tolerances in the tool measurement and due to different cutting forces and other effects. They cannot be avoided altogether. One possibility of reliably avoiding steps on the workpiece surface is a “creeping” entry of the smaller consecutive tools. In a way similar to the one described for the sister tools, the tool starts machining of the small inner radii in an area where the workpiece surface was previously already produced by a larger tool and remains first slightly above the workpiece tool. The machining program is then configured such that the machining tool slowly (e.g. in lines) moves towards the small radius, a “creeping” supply movement taking place again, so that the small tool very slowly immerses into the surface of the workpiece and establishes an almost tangential transition.

The same method is used according to the invention also at the end of the machining operation with the smaller tool when said tool adjoins again a surface that was previously machined with a larger tool. Instead of completing the machining operation suddenly, the machining program will enter the area of the workpiece surface that was previously machined by the larger tool, and the machine will very slowly increase the tool correction during machining, so that an almost tangential exit of the workpiece surface machined with the small tool is created in the workpiece surface machined with the larger tool.

The invention is now described in the following with reference to embodiments taken in conjunction with the drawing, in which:

FIG. 1 is a schematic illustration of the machining situation of a workpiece by means of a tool in the lifted-off state of the tool;

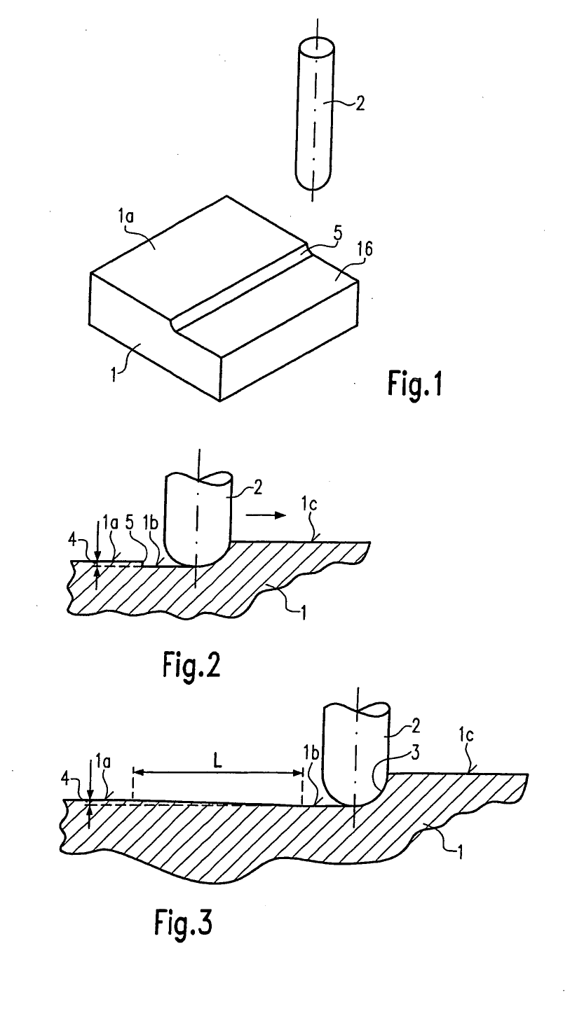

FIG. 2 is an illustration of an error correction according to the prior art;

FIG. 3 is an illustration of an error correction according to the present invention;

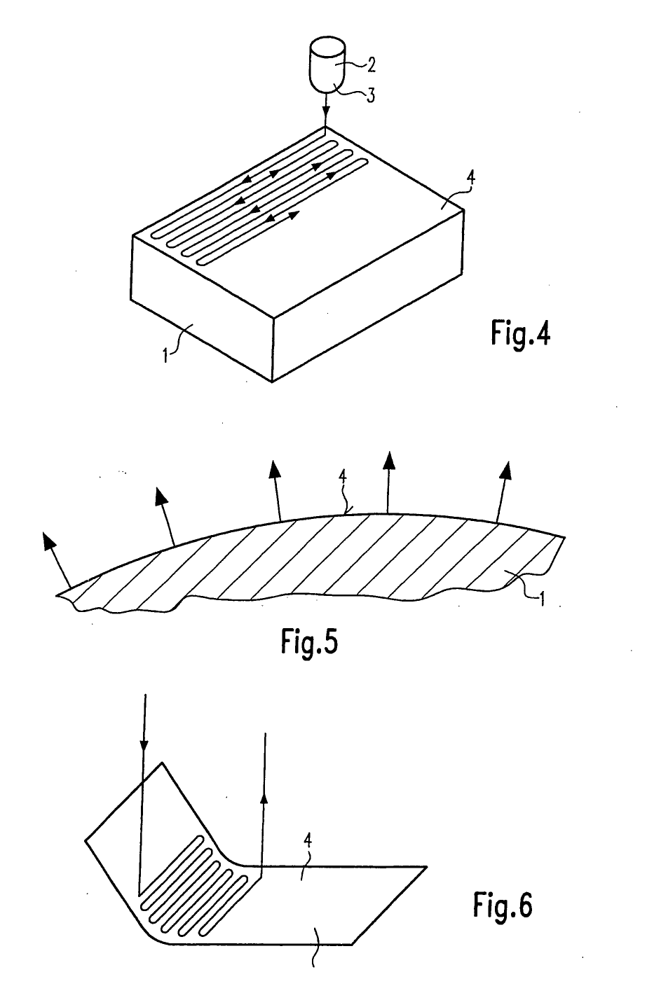

FIG. 4 is a schematic illustration of the movement of a tool relative to a workpiece;

FIG. 5 is a schematic illustration of the feed directions of a tool relative to a workpiece surface; and

FIG. 6 is an illustration of a curved workpiece surface in the machining process of the invention.

FIG. 1 is a very schematic illustration of a workpiece 1 which is machined by means of a rotating tool 2 (milling cutter, grinding tool, or the like). The tool 2 is provided at its face end with at least one cutting edge 3.

FIG. 1 shows a machined area 1a where a worn tool has been used. That is why the amount of material removed on area 1a is too small. Area 1b shows a machined area with a correct material removal. The difference in height shown in FIG. 2 leads to a step 5 between areas 1a and 1b. The height difference of step 5 is due to the fact that in the prior art the machining of surface 1a is interrupted and the tool is measured. It is discovered that said tool has not been fed adequately by the height difference (see FIG. 2) towards the workpiece 1. Thereupon, the feed is increased. Although this yields correct measures for surface 1b, the above-described step is formed during further machining (see horizontal arrow in FIG. 2). This step must be re-machined later.

FIG. 1 shows the machining operation according to the prior art after the machining process has been terminated and the tool 2 has been lifted. FIG. 2 shows the machining operation according to FIG. 1 during the subsequent machining operation. Reference numeral 1c refers to an area which has not been machined yet and in the direction of which tool 2 is moved. As can be seen from FIG. 2, the feed has changed by the amount of the height difference h after the wear measurement has been carried out. This forms the edge of step 5.

FIG. 3 shows the inventive situation. A “creeping” correction is there carried out over path length L until tool 2 is fed for the compensation of the height difference h. The formation of the edge or step 5 is thereby avoided. Length L can be defined through the path, the machining time or the machining speed, as has been described above.

FIG. 4 schematically shows the meandering direction of movement of a tool 2 relative to a workpiece surface 4 of a workpiece 1.

FIG. 5 shows a workpiece 1 with a convex workpiece surface 4. As can be seen, the feed direction of the tool 2 (not shown) is normal, i.e. perpendicular, to the workpiece surface 4. FIG. 5 shows the normal vectors in an exemplary view.

FIG. 6 shows a situation of a workpiece 1 with a concave bend or edge. The illustrated operative sequence shows the machining process carried out by a tool 2 (not shown) which has a smaller head radius and is therefore suited for machining the concave edge. It becomes apparent that steps or edges can be avoided by way of a “creeping” entry of the feed during use of the substitute tool 2 and by way of a corresponding “creeping” exit before the replacement of the tool.

1. A method for machining a workpiece, comprising:
(a) providing a rotating tool having at least one cutting edge;
(b) interrupting, at a predetermined time interval, a machining operation utilizing the rotating tool;
(c) performing a measurement on the rotating tool during said interruption to determine a wear measurement;
(d) continuing the machining operation by returning the rotating tool into a feed position substantially identical to a feed position of the rotating tool prior to the interruption; and
(e) feeding the tool into contact with a work piece in a manner to compensate for the wear measurement determined in accordance with step (c).

2. The method according to claim 1, wherein one of a speed of the rotating tool or a period of time of a continuous feed of the tool is defined in relation to a machining path.

3. The method according to claim 1, wherein one of a speed of the rotating tool or a period of time of a continuous feed of the tool is defined through a machining time.

4. The method according to claim 1, wherein one of a speed of the rotating tool or a period of time of a continuous feed of the tool is defined through the wear measured.

5. The method according to claim 1, further comprising generating at least one of an error message or a warning message transmitted if a wear measurement is not being completed by the expiration of a predetermined time interval set for carrying out a wear measurement.

6. The method according to claim 1, wherein the wear measurement comprises measuring wear along the entire cutting edge of the tool.

7. The method according to claim 1, further comprising compensating for the wear measured by performing corrections carried out sectionwise for individual small sections along a cutting edge of the tool.

8. The method according to claim 1, wherein the wear measurement comprises a measurement on an enveloping body formed during rotation of the tool.

9. The method according to claim 1, wherein the tool is fed for wear correction in a direction perpendicular to a workpiece surface.

10. The method according to claim 9, wherein said method is carried out on the basis of an engagement point of the cutting edge of the tool as predetermined by a machining program.

11. The method according to claim 9, wherein said method is performed using an online calculation of one or more engagement points of the cutting edge of the tool said calculation being dependent upon the amount of material removed from the workpiece.

12. The method according to claim 1, wherein a predetermined time interval is determined on the basis of material removed by a cutting edge of the tool.

13. The method according to claim 1, further comprising changing the tool when a predetermined maximum total wear of the tool has been reached.

14. The method according to claim 1, further comprising continuing the machining operation with a replacement tool by positioning said replacement tool at substantially the same place that said rotating tool occupied prior to said step of interrupting and continuing the feed of the replacement tool against the workpiece using a smaller value such that the replacement tool is not yet in engagement with the workpiece at the beginning of the continued machining operation.

15. The method according to claim 1, further comprising, after the wear measurement has been formed, continuing the machining operation at a slightly superelevated level to compensate for errors caused by wear on the tool and to compensate for elastic deformations of the tool.

16. The method according to claim 15, wherein the machining operation is carried out in at least one of a lateral direction or in a normal direction relative to a surface of the workpiece in order to compensate for any lateral deviations of the tool.

17. The method according to claim 1, wherein the machining operation is carried out in a linear fashion.

18. The method according to claim 1, wherein the machining operation is carried out in a non-linear fashion.

19. A method for machining a workpiece by means of a rotating tool provided with at least one cutting edge, in which method a machining operation is interrupted at predetermined time intervals, the tool is moved away from the workpiece, and a wear measurement is subsequently carried out on the tool, comprising:
(a) returning the tool, after conducting a wear measurement thereof, into a feed position assumed by the tool before an interruption of a machining operation and within a subsequent period of time after said returning step;
(b) continuously feeding said tool into contact with a workpiece in a manner that compensates for the wear measured.

20. The method of claim 19, wherein said step of continuously feeding is determined by assessing a machining path as it relates to at least one of a speed of rotation of said tool and a period of time that the tool has been in contact with the workpiece.
